(19) United States
(12) Patent Application Publication
(10) Pub. No.: US 2008/0228303 A1
(43) Pub. Date: Sep. 18, 2008

(54) DIRECT MANUFACTURE OF DENTAL AND MEDICAL DEVICES

(76) Inventor: Stephen M. Schmitt, San Antonio, TX (US)

Correspondence Address: COX SMITH MATTHEWS INCORPORATED, 112 EAST PECAN STREET, SUITE 1800, SAN ANTONIO, TX, 78205-1521, US

(21) Appl. No.: 12/048,047

(22) Filed: Mar. 13, 2008

Related U.S. Application Data
(60) Provisional application No. 60/906,708, filed on Mar. 13, 2007.
(60) Provisional application No. 61/031,964, filed on Feb. 27, 2008.

(51) Int. Cl. G06F 17/00

(52) U.S. Cl. 700/98

(57) ABSTRACT

A method of making a medical or dental part may comprise creating a first digital model, manufacturing an initial embodiment of the part based on the first digital model using a layered manufacturing process, creating a second digital model of the initial embodiment of the part, determining the difference between the second digital model and the first digital model, and machining the initial embodiment of the part to create a final embodiment of the part by removing an amount of material substantially representative of the difference. A computer readable medium for performing such method is also disclosed.

### CROSS-REFERENCE TO RELATED APPLICATIONS

This application claims priority to and the benefit of the filing date of U.S. Provisional Patent Application No. 60/906,708 filed Mar. 13, 2007, and U.S. Provisional Patent Application No. 61/031,964, filed Feb. 27, 2008, both of which are incorporated herein by reference in their entirety.

### FIELD

This application generally relates to dentistry and medicine, and more particularly to a system and method of making dental restorations, dental prostheses, surgical fixation devices, surgical drill guides, dentures, removable partial dentures, dental implants, and other medical devices.

### BACKGROUND

Dentists have found it useful to have a precise model or replica of a patient's anatomy when analyzing and treating disorders of the jaws and making a dental prosthesis. A dentist or prosthodontist will generally need a model of an area of a patient's mouth where one or more teeth are missing and need replacement. This model can be used in the dental lab to adjust and fit replacement teeth for proper size and shape, eliminating the need for the patient to be present.

To create physical models, typically an impression of the patient's upper and lower dental arch is first obtained. The impression is made by placing a curable material in an impression tray and positioning the tray over the patient's teeth and gums. After the material has cured, it and the tray are removed from the mouth. The same process is used for both the upper and lower jaw. The actual dental model is then made by pouring or placing a second curable material in the cured impression material. After the second material has cured, the impression material is removed to produce the dental model. Properly made, these dental models provide an accurate physical replica of the patient's upper and lower teeth as well as the adjacent soft tissue. Modern impression materials can create models that reproduce detail as fine as 10 microns.

If a crown is made and attached to a dental implant abutment or tooth stump, first an impression is made of the tooth stump and a curable material such as plaster is cast into the mold to produce a reproduction of the stump. Next, a dental technician manually adds wax to the plaster stump to create a pattern that has the shape of the missing tooth and has proper contact with adjacent teeth and opposing teeth. This is a very subjective process developed over many years of training. The wax pattern is then placed in a curable investment and heated in a furnace to remove the wax and expand the mold. Molten metal is injected into the mold to replace the wax, the investment is removed, the metal part is cut from the remaining metal, the surface of the metal is ground and polished by hand, and the crown is ready to be cemented to the stump.

Even though numerous operations are carried out by highly skilled dental technicians, many times the prosthesis still requires additional modification to be acceptable. The metals used in the manufacture of the prosthesis are also a problem since they must be fluid and malleable at easily obtainable temperatures. The metal castings frequently have areas of porosity due to the casting process, which results in undesired weakness.

The use of computer-aided design (CAD), computer-aided manufacturing (CAM), and number controlled (NC) milling has solved some of the problems associated with the above described casting process. Metals that are difficult to cast like titanium can be machined from a blank of material to produce a fully dense part with high precision. Unfortunately, milling has limitations in the type of shapes that can be created. Undercut areas and small precise geometries are difficult to make using milling, and the creation of open areas that allow for bone in-growth or for the retention of bioactive materials are also difficult to make.

Electron beam melting (EBM) is a new method of creating metal parts directly from CAD data. This method of layered manufacturing enables creation of a part by selectively melting metal powder a layer at a time using the energy created by an electron beam in a vacuum. This process makes it possible to create complex parts that are fully dense from metals like titanium that are difficult to cast using conventional processes. The physical properties can be further improved by hot isostatic pressure (HIP) treatment if necessary. However, the outer surface of parts created with EBM is generally rough and may be 100-200 microns larger or smaller than the geometry of the CAD design. Consequently, parts made with EBM are generally unacceptable for dental implant application without further processing to achieve the needed precision.

### SUMMARY

A method of making a medical or dental part may comprise creating a first digital model, manufacturing an initial embodiment of the part based on the first digital model using a layered manufacturing process, creating a second digital model of the initial embodiment of the part, determining the difference between the second digital model and the first digital model, and machining the initial embodiment of the part to create a final embodiment of the part by removing an amount of material substantially representative of the difference. A computer readable medium for performing such method is also disclosed.

### BRIEF DESCRIPTION OF THE DRAWINGS

FIG. 1 is a schematic diagram of a system for direct manufacturing of dental and medical devices.

FIG. 2 is a schematic front view of an EBM machine with a dental prosthesis being made.

FIG. 3A is a perspective view of a metal EBM part attached to a fixation device being imaged with a contact digitizing probe.

FIG. 3B is a perspective view of a digital three-dimensional image of the EBM part from FIG. 3A.

FIG. 4A is a side view that shows a digitized image of a metal EBM part.

FIG. 4B is a side view of an image of an EBM part superimposed over a CAD design of a dental prosthesis.

FIG. 4C is a side view of a CAD design in the same spatial orientation as FIG. 4B.

FIG. 5 is a side view that illustrates tool-paths generated from the spatial orientation of a CAD design of a prosthesis.

FIG. 6 is a side view of a five-axis NC mill removing excess material from an EBM part.

FIG. 7 is a perspective view of a patient's jaw bone and an artificial bone plate, with a partial cross sectional view of the bone plate.

FIG. 8 is an enlarged view of a cross section of an artificial bone plate illustrating openings for bone in-growth and spaces for insertion of bio-active materials.

FIG. 9 is a top perspective view of a virtual design of a dental prosthesis.

FIG. 10 is a front perspective view of a virtual treatment plan of a dental implant patient.

FIG. 11 is a perspective view of a polished titanium dental prosthesis part.

FIG. 12 is a front view of a dental prosthesis with incorporated supporting structures.

FIG. 13 is a perspective view of a bone plate and dental prosthesis attached to a jaw bone.

### DETAILED DESCRIPTION

As used herein, the following terms should be understood to have the indicated meanings:

When an item is introduced by “a” or “an,” it should be understood to mean one or more of that item.

“Abutment” means a tooth, artificial tooth, or portion of a tooth or artificial tooth, or a combination thereof, used as an anchorage for either a fixed or a removable dental prosthesis.

“Component” means any part, feature, or element, alone or in combination.

“Comprises” and “Comprise” means includes but is not limited to.

“Comprising” means including but not limited to.

“Coping” means a metal covering or cap that may include but is not limited to a plate of metal applied over a prepared crown or root of a tooth prior to attaching an artificial crown and may be used as an abutment for dentures.

“Crown” means the upper portion of a natural tooth or the upper portion of an artificial tooth.

“Denture” means an artificial or prosthetic replacement for a partial or complete set of artificial or natural teeth to replace or augment missing natural teeth for functional, prosthetic, cosmetic, experimental, or therapeutic purposes, or for a combination of purposes. “Denture” may include but is not limited to an artificial or prosthetic replacement of natural teeth and associated mandibular and maxillary structures, gums, or adjacent tissues.

“Removable Partial Denture” means a denture that replaces one or more natural teeth and can be readily placed in the oral cavity and removed by the wearer. “Removable Partial Denture” may include but is not limited to a denture that may be supported by residual teeth, residual tissue, or both residual teeth and residual tissue.

“Digitize” means to convert an analog or physical measurement of a quantity into a digital or numerical value.

“Fastened” means, with respect to two or more components that are attached to each other, attached in any manner, including but not limited to attachment by one or more bolts, copings, screws, nuts, pins, stitches, staples, brads, rivets, adhesives, straps, wire ligatures, elastics, arch bars, splints, bracing, strapping, or using a fitting or a combination thereof.

“Fastening” means, with respect to two or more components that are attached to each other, attaching in any manner including but not limited to attaching by one or more bolts, copings, screws, nuts, pins, stitches, staples, brads, rivets, adhesives, straps, wire ligatures, elastics, arch bars, splints, attaching by bracing, strapping, or using a fitting or a combination thereof.

“Fixation device” means a device used for holding, suturing, or fastening in a fixed position.

“Having” means including but not limited to.

“Implant” means a material, object, or artificial substitute surgically inserted or grafted or embedded into the body for functional, prosthetic, cosmetic, experimental, or therapeutic purposes, or for a combination of purposes.

“Metal” means having at least one of any of a class of elementary substances which are at least partially crystalline when solid. “Metal” may include but is not limited to gold, silver, copper, iron, steel, brass, nickel, zinc, aluminum, titanium, or a combination thereof, including but not limited to an alloy.

“Prosthesis” means a material, object, or artificial substitute to replace or augment a missing or impaired body part, inserted into tissue, or placed, fixed, or attached for functional, cosmetic, experimental, or therapeutic purposes, or for a combination of purposes. “Prosthesis” may include but is not limited to an artificial eye, tooth, set of teeth, dentures, removable partial dentures, dental crown, leg, arm, gums, or jaw bone, used for functional, cosmetic, experimental, or therapeutic purposes, or for a combination of purposes.

“Dental Prosthesis” means a material, object, or artificial substitute to replace or augment one or more missing or impaired natural teeth, or part of a natural tooth, or associated structures or tissues, ranging from a portion of a tooth to a complete denture, inserted into tissue, placed, fixed or attached in the mouth or to the mouth for functional, cosmetic, experimental, or therapeutic purposes or a combination of purposes.

“Periodontal Prosthesis” means any prosthesis that is used as a therapeutic aid in the treatment of periodontal disease.

U.S. patent application Ser. No. 11/674,956 filed Feb. 14, 2007, Ser. No. 11/739,310 filed Apr. 24, 2007, Ser. No. 11/867,590 filed Oct. 4, 2007, Ser. No. 11/851,105 filed Sep. 6, 2007, and U.S. Provisional Patent Application Nos. 60/773,433 filed Feb. 15, 2006, 60/794,996 filed Apr. 26, 2006, and 60/993,005 filed Sep. 10, 2007 are incorporated herein by reference. The methods discussed in the above references may be used as a basis for creating virtual models used in some embodiments. One embodiment comprises a method of free form fabrication of metal or ceramic components by EBM of powders using CAD data. The powders can be used in an EBM system such as the EBM S12 system from Arcam AB (MÖLNDAL, SWEDEN). The design of a prosthesis may be made with fixation struts attached to the part such that the part can be imaged and subsequently machined using NC milling. The part is created by building the part layer by layer and selectively melting each layer with the electron beam to produce a fully dense near-net part. In addition to EBM, of course, other layered manufacturing processes may be used, such as stereolithography, for example. The layer thickness of the powder is typically 50-100 microns, and melting the surface can produce an irregular shape that can be 200 microns larger or smaller than the actual CAD model. After the part has been removed from the EBM machine and the powder removed, the part is attached to a fixation device that allows the part to be digitized and subsequently machined with NC milling to create a part with precise machined surfaces. The digitizing can be accomplished with contact, laser, or light imaging for quality control. After the part has been digitized, the three-dimensional model of the EBM part is evaluated by superimposing the three-dimensional design model over the digitized EBM part to determine the three-dimensional position for the tool-paths required to produce the final precise prosthesis. If the digitizing indicates that the EBM part is too small to have adequate excess material for machining, the original CAD design can be made larger to have adequate excess material.

One embodiment as described herein is directed to a method of manufacturing dental restorations, dental prosthesis, surgical fixation devices, surgical drill guides, dentures, removable partial dentures, dental implants, and other medical devices.

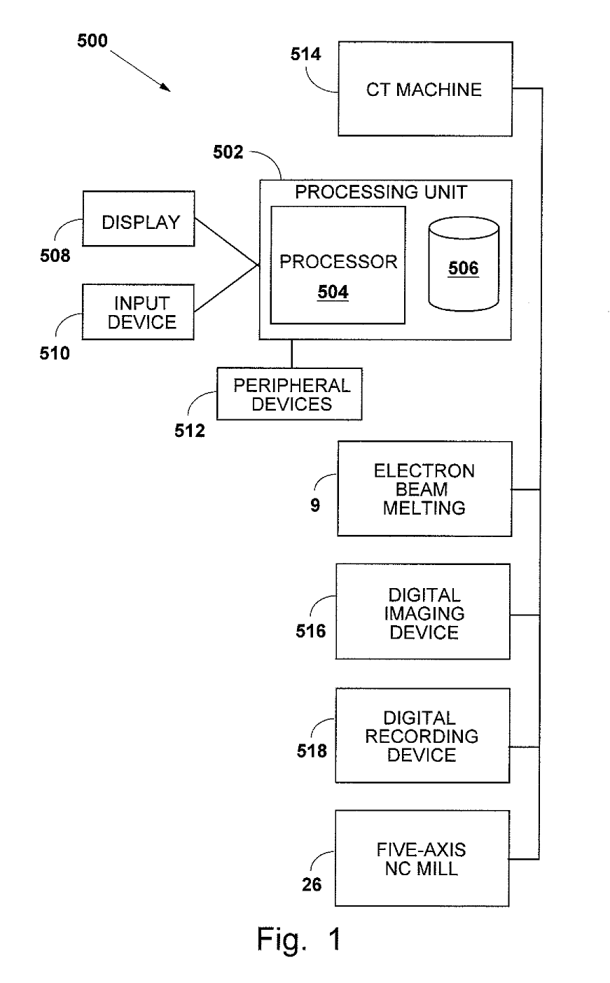

FIG. 1 is a schematic diagram of a system for performing the processes and methods described herein. FIG. 1 includes a computer system 500 including a processing unit 502 containing a processor 504 and a memory 506. Memory 506 is sometimes referred to herein as a computer readable medium, which may be part of or separate from processing unit 502. An output device, such as a display 508, and input devices 510, such as keyboards, scanners, and others, are in communication with the processing unit 502. Additional peripheral devices 512 also may be present.

The processor 504 may for example be a general purpose computer, personal computer, or microprocessor of a known type. The memory 506 may, in some embodiments, collectively represent two or more different types of memory, some of which may be portable (e.g., CD, DVD, thumb drive, and the like). For example, the memory 506 may include a read only memory (ROM) that stores a program executed by the processor 504, as well as static data for the processor 504. In addition, the memory 506 may include some random access memory (RAM) that is used by the processor 504 to store data that changes dynamically during program execution. The processor 504 and the memory 506 could optionally be implemented as respective portions of a known device that is commonly referred to as a microcontroller. The memory 506 may contain one or more executable programs to carry out the methods contained herein, including joining, separating, storing, and other actions including Boolean actions.

Some embodiments may include a computed tomography (CT) machine 514, which may include but is not limited to cone beam computed tomography (CBCT), laser imaging, light imaging, or a combination of methods to provide precise, three-dimensional information of a patient's anatomy.

Some embodiments may include an EBM machine 9 and a five-axis or other suitable NC mill 26 that may communicate with the computer system 500 by any suitable method, including but not limited to through the use of a computer network, by direct communication, by storing and physically delivering, such as using a removable disk, a memory storage device, a removable drive, or other removable storage device, over e-mail, or using other known transfer systems over a network, such as a LAN or WAN, including over the internet or otherwise.

A digital imaging device 516, such as a contact digitizer, laser digitizer, light digitizer, holographic digitizer, or other digitizer may be used in some embodiments to digitize an EBM part including but not limited to dental restorations, dental prostheses, surgical fixation devices, surgical drill guides, dentures, removable partial dentures, dental implants, and other medical devices.

A digital imaging device 516 may be used to digitize a physical dental model manufactured from a casting method to generate a digital image. A digitized physical dental model may be compared with a CT machine 514 image to allow the computer system 500 to generate a composite digital image of the patient's physical anatomy.

A digital recording device 518 may include but is not limited to a CT machine 514, a digital imaging device 516, or a digital recorder described herein. In some embodiments, data from the CT machine 514, the digital imaging device 516, the EBM machine 9, the five-axis NC mill 26, and the digital recording device 518 may be accessed by the processing unit 502 and used to carry out the processes and methods disclosed herein. Additionally, in some embodiments data may be communicated to and from the processing unit 502, the EBM machine 9, the five-axis NC mill 26, digital imaging device 516, digital recording device 518, or CT machine 514 by any suitable method, including but not limited to through the use of a computer network, by direct communication, by storing and physically delivering, such as using to a removable disk, a memory storage device, using a removable drive, or other removable storage device, over e-mail, or using other known transfer systems over a network, such as a LAN or WAN, including over the internet or otherwise. Such communication may be wired, wireless, or any other suitable means. Any data received at the processing unit 502 may be stored in the memory 506 for processing and manipulation by the processor 504. In some embodiments, the memory 506 may be a storage database separate from the processor 504.

In one alternative embodiment, a processing unit 502 connected to a WAN, including but not limited to the Internet, can communicate data, including STL (stereolithography) format files containing modeled data to a remote computer, a separate machine such as a five-axis NC mill 26, an EBM machine 9, or any other machine that may be connected to the processing unit 502. In one embodiment, the remote computer may be associated with a remote dentist or other provider. Using the remote computer, the remote provider may access the images on a processing unit 502, and may edit the images as desired. SpinFire™ software available from Actify, Inc. (San Francisco, Calif.) or other suitable software may be used to enable such editing. Once edits or modifications are made, the revised data may be sent directly to a machine including but not limited to a five-axis NC mill 26 or an EBM machine 9 to create the desired dental or medical devices.

In one embodiment, a remote dentist or other provider may register for the ability to edit images on a processing unit 502 to edit the images as desired. In another embodiment, a machine such as a five-axis NC mill 26, EBM machine 9, or other automated machine may be located in a dentist or other provider's office. While a patient is stationary, the remote dentist could edit the images using real-time data of the patient, then send the data to an automated machine to drill, operate on the patient, or install medical or dental devices in the patient.

In some embodiments, a patient may be first scanned using a CT Machine 514. The CT Machine 514 generates CT data that allows the dental technician to record the position of the patient's teeth, jaw, and surrounding tissues and produce a virtual computer model of the patient's dental anatomy. Additionally, CT data may be used for orienting a patient's jaws, teeth, soft tissue, and supporting bone in the virtual computer model, which may eliminate the use of a face bow and mechanical articulator. In addition, CT data about the patient may be recorded such that the aesthetic portion of the teeth, head, eyes, lips, ears and any other soft or hard tissue can be measured and recorded in relation to “natural head position” such that the data will represent the patient with normal head posture. Once created, the virtual computer model can also incorporate movement from a digital recording device 518 such as the ARCUSdigma machine (KaVo Company) or any other digital recorder that measures lower jaw movement in relation to the maxillary teeth or maxillae. This virtual model can also simulate motion of the lower jaw in relation to the upper jaw by using known standard angulations and approximations for the distance of the teeth from the rotational centers. Many semi-adjustable mechanical articulators are designed with similar average or standard settings.

A radiolucent CT bite plate may be used to record the position of the patient's teeth during CT imaging. The CT bite plate may be rigid and may include three or more non-linear radiographic markers imbedded in it. Bite registration material may be placed on the bite plate and the patient may bite into the material to record a specific jaw position. The CT bite plate may include an extension that projects through the lips and extends vertically away from the plane of occlusion and laterally around and away from the soft tissues of the face. The radiographic markers can be detected in the CT image but do not create scatter. The CT bite plate may then be used at the time of CT imaging to position the patient's teeth and jaws in a known relationship or orientation and to create radiographic images of the position of the CT bite plate in the CT scan. If a CBCT is used that allows the patient to sit upright, the head is positioned in a natural head position or any other diagnostic position that is desired for aesthetic and diagnostic analysis. The resulting image will have the position of the teeth and soft tissues recorded in relation to horizontal, thus orienting a patient's jaws, teeth, soft tissue, and supporting bone in the virtual computer model.

In another embodiment, a digital data set may also be made of the patient's teeth and soft tissues using non-radiographic imaging of the teeth and tissues directly in the mouth with photographic, light, laser, holographic or any other imaging system that will record the teeth with an acceptable precision.

An alternative embodiment is to make conventional physical dental impressions of the upper and lower jaws and then digitize the physical dental casts made from the impressions. If physical dental casts are made, they can be scanned with a digital imaging device 516, such as a contact digitizer, laser digitizer, light digitizer, or other device to digitize the physical dental cast so the computer system 500 may generate a three-dimensional data set and STL (stereolithography) format or other suitable file for each of the upper arch and the lower arch. In this alternative embodiment, the digitized image and STL format file of the physical dental cast of the upper and lower arch of the patient may then be overlaid on the digital image generated from the CT scan with the three radiographic markers. The three radiographic markers from the CT scan may be used to align the three-dimensional data set and STL format file from the physical dental cast in computer space to have substantially the same orientation and relative position as the patient's actual teeth. The overlaid images allow the dental professional to compare or correct any radiographic scatter in the CT scan digital image using computer software to create an accurate virtual computer model of the patient's teeth, surrounding tissues, bone structure, orientation, oral cavity, and three-dimensional orientation and positional relation of each.

After a digital image of the patient's dental structure is generated, a dental technician may manipulate the virtual computer model using various CAD and CAM software tools on the processing unit 502. In one embodiment, CADKEY, manufactured by the Kubotek Corporation or similar software, may be used to find the three radiographic markers that allow a virtual computer model to be moved in computer space such that three dimensional data sets for the dental casts or teeth made using non-radiographic techniques are in the same orientation as the CT data set. In some embodiments, CADKEY or similar software may also be used to find three corresponding points from a digitized scan of actual laboratory replicas of teeth or healing abutments. The digitized scan of actual laboratory replicas of teeth or healing abutments may be moved into the same XYZ position or orientation as the virtual computer model generated from CT data or the digitized dental casts. The moving of one scan into the XYZ orientation of another can be done using a CADKEY software function called XFORM old-new. Of course, other suitable software may be used as well.

In some embodiments, once the digitized scan of actual laboratory replicas of teeth or healing abutments and the virtual computer model generated from CT data or the digitized dental casts are in the same XYZ orientation in computer space, they may be combined together to make a single virtual computer model that has the desired components to make a virtual treatment plan 55 as illustrated in FIG. 10. Additionally, in some embodiments, a Boolean operation may be performed to remove, for example, the patient's original teeth from the virtual computer model and replace in the same XYZ orientation in computer space images of actual laboratory replicas of teeth or healing abutments, including but not limited to virtual implants 56 (see FIG. 1O).

It should be noted that in some embodiments, a T file may be generated from the digital imaging device 516 that records all of the XYZ points for the digitized scan. In some embodiments, a dental technician may import a DXF format file, converted from a T file, of each digitized scan into a surfacing software program such as Rhinoceros—NURBS modeling for Windows (Rhino), V.2.0, sold by McNeel North America in Seattle, Wash. Rhino converts poly lines, imported from a DXF format file, and creates a virtual computer model. Again, other suitable software and file formats may be used.

Additional software called Plug-ins can be added to Rhino software to provide additional functions. For example, Floating Point Solutions software sold by Goa of India provides point extraction and surfacing plug-ins that extract point data and then create a surface from the points. The surface data can then be output from the Rhino software as an STL format file. In other embodiments, software such as 3D-doctor, owned by Able Software Corporation of Lexington, Mass., may be used to render CT data into a volume rendering that generates a grayscale gradient correlating to density of the particular anatomy from the CT data. Data from a CT scan may be saved as two dimensional grayscale bitmaps (DICOM format) and can be processed with volume rendering software to create three-dimensional data sets of objects with specific grayscale values. Each object can then be saved as a three-dimensional object in a known position in computer space, and Boolean operations may be performed for example, to view only teeth, or jaw structure, or surrounding tissue. Once again, other suitable software programs and file formats may be used.

In some embodiments, the combining of different virtual computer models from CAD and CAM data in the processing unit 502 allows the dentist or dental technician to manufacture dental or medical devices, including but not limited to dental prostheses, surgical fixation devices, surgical drill guides, dentures, removable partial dentures, dental implants, or other medical devices using a process called electron beam melting (EBM). The processing unit 502 may export the data necessary to make the dental or medical devices using an EBM machine 9. The surface of parts created with EBM are usually relatively rough and may be about 100-200 microns larger or smaller than the geometry of the CAD or CAM design. Parts made with EBM are generally unacceptable for dental implant application without further processing to create the 10-30 micron fit desired between dental implants and a prosthesis.

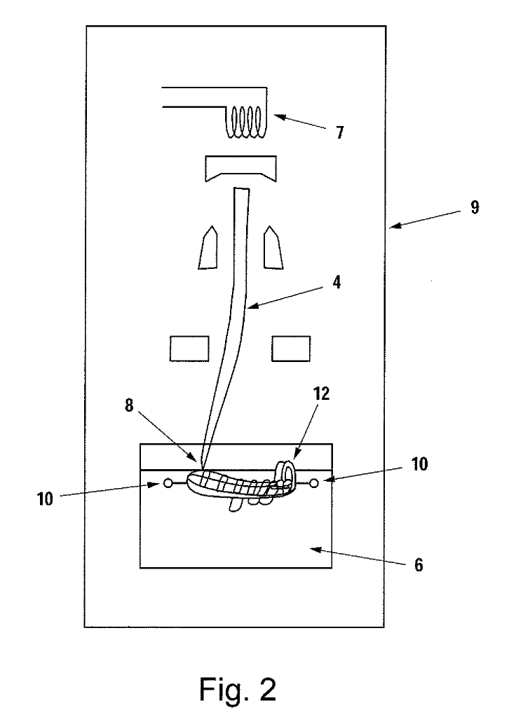

FIG. 2 illustrates an EBM machine 9. Electrons are created by a filament 7 and accelerated into a beam 4 in a vacuum, projected onto metal or ceramic powder 6 at a specific point 8 to create heat to melt the metal or ceramic powder 6 at that specific location. Metal or ceramic powder 6 is built up in layers to provide support for the part and to allow for selective melting. Typically, the layer thickness of the metal or ceramic powder 6 is 50-100 microns, and melting the surface can produce an irregular shape that can be about 200 microns larger or smaller than the actual CAD or CAM virtual computer model. The prosthesis 12 may be created with fixation struts 10 that provide a means for holding the part for digital imaging and NC machining to achieve the 10-30 micron fit typically desired between a dental implant and prosthesis.

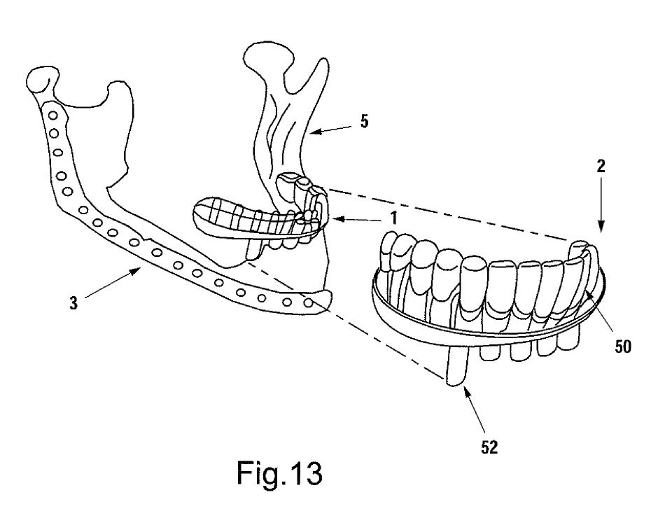

In some embodiments, as shown in FIG. 13, the EBM machine 9 may directly manufacture an artificial bone plate 3. Traditional NC milling cannot create some aspects of a desired dental or medical substructure. As shown in FIG. 8, EBM may be used to manufacture certain unique retentive surfaces and undercut areas that cannot be milled. Unique holes and recesses 30 in an artificial bone plate 3 may be manufactured using EBM. Additionally, EBM may be used to create medical and dental devices that have openings 34 in the surface for bone in-growth and surfaces that are conducive to the migration of bone cells. In an alternative embodiment, the EBM machine 9 may manufacture surfaces that have openings or recesses that can retain bioactive materials which can improve bone healing and growth. In one alternate embodiment, the EBM S12 system from Arcam AB (MÖLNDAL, SWEDEN) may be used to manufacture metal or ceramic components using CAD data.

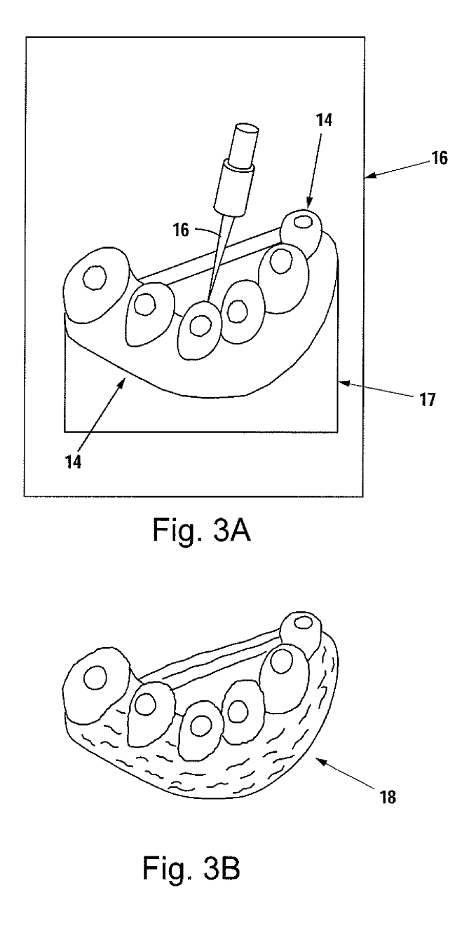

As discussed previously, the surface of parts created with EBM is generally relatively rough. The EBM part may be digitized to enable a processing unit 502 to send data to a numerically-controlled mill or other suitable machine for machining the EBM part to reduce the roughness to an acceptable degree of precision. FIG. 3A illustrates a manufactured EBM part 14 joined to a reference mounting plate 17. The reference mounting plate 17 may comprise three reference points that relate to the CT scan radiographic markers. The manufactured EBM part 14 is positioned in a contact digitizer 16 to generate a data set of the three-dimensional surface of the manufactured EBM part 14 in a known spacial relationship to the reference mounting plate 17. The manufactured EBM part 14 may also be imaged or scanned using light, laser, radiographic, holographic, acoustic, or any other method that will scan a manufactured EBM part 14 and generate digital data, including but not limited to a digital image.

In one embodiment, a MAXNC 15 CL2 machine (MaxNC, Gilbert, Ariz.) may be used to scan the manufactured EBM part 14 to generate the digital data. A MAXNC 15 CL2 machine is a mount model that allows a manufactured EBM part 14 to be securely fastened to ensure limited movement of the manufactured EBM part 14 while the machine transposes the coordinates of the manufactured EBM part 14 into digital data.

Digital data can be stored in a memory 506 of a computer system 500 as a text file recording specific XYZ points in relation to a reference mounting plate 17. As illustrated in FIG. 3B, the XYZ points can be processed to produce a mathematical surface or solid model of the manufactured EBM part 14 using mathematical algorithms known in the imaging art to create a virtual EBM model 18. The surface of the virtual EBM model 18 may be saved as a STL (stereolithography) format or other suitable file which represents the surface as a series of small triangles. Of course, other suitable digital models may be used.

A person skilled in the art will recognize the virtual EBM model 18 may be overlaid on the digital image generated from the CT scan or the original three-dimensional CAD design of the part 20. The overlaid images allow the dental professional to determine how much excess material of the manufactured EBM part 14 should be machined to match the digital image generated from the original three-dimensional CAD design of the part 20. Additionally, the overlaid images may show a dental professional that the manufactured EBM part 14 is too small and therefore must be enhanced or manufactured again through the EBM machine 9 or other suitable means.

The STL format file may then be used by a rapid prototyping software, such as Desk Proto v. 4.0 by Delft Spline System, of Holland, for example, to generate tool paths for a five-axis NC mill 26 to mill the manufactured EBM part 14.

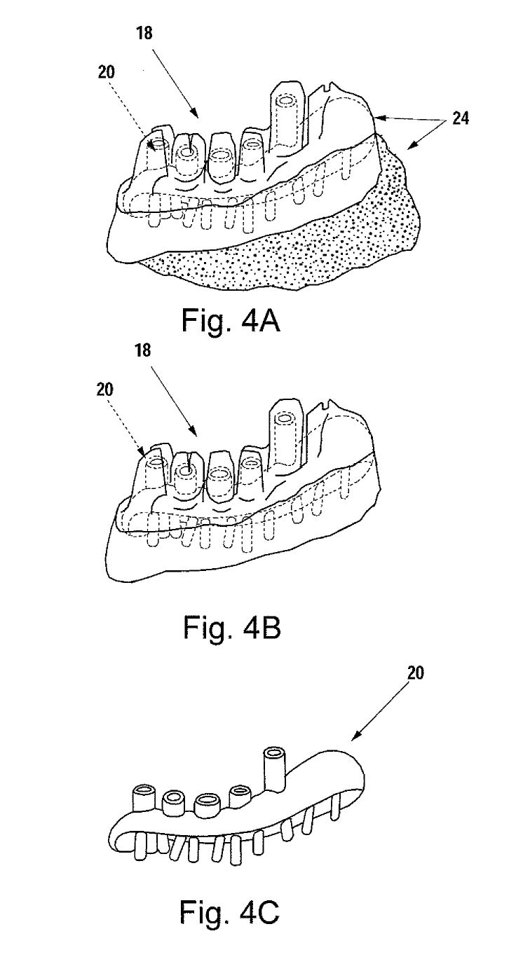

FIG. 4A illustrates a digital image of virtual EBM model 18 along with the excess EBM material 24. Computer software may perform a Boolean operation to display the difference between the original three-dimensional CAD design of the part 20 shown in FIG. 4C and the virtual EBM model 18 of the actual EBM part 14. All or part of the excess EBM material 24 in the virtual EBM model 18 may be removed by a Boolean operation. Second programming data may be generated for operating a tool cutting machine to cut shapes corresponding to the excess EBM material 24 removed by the Boolean operation. The second programming data may be transferred to the tool cutting machine, and the actual dental or medical device may be machined to match the original three-dimensional CAD design of the part 20 by removing the excess EBM material 24. FIG. 4B illustrates virtual EBM model 18 and the original three-dimensional CAD design of the part 20 superimposed over the scan data, which may be used to generate a tool path for the five-axis NC mill 26 to remove the excess EBM material 24. FIG. 4C illustrates the original three-dimensional CAD design of the part 20 in the same spatial orientation as the virtual EBM model 18 from FIG. 4B.

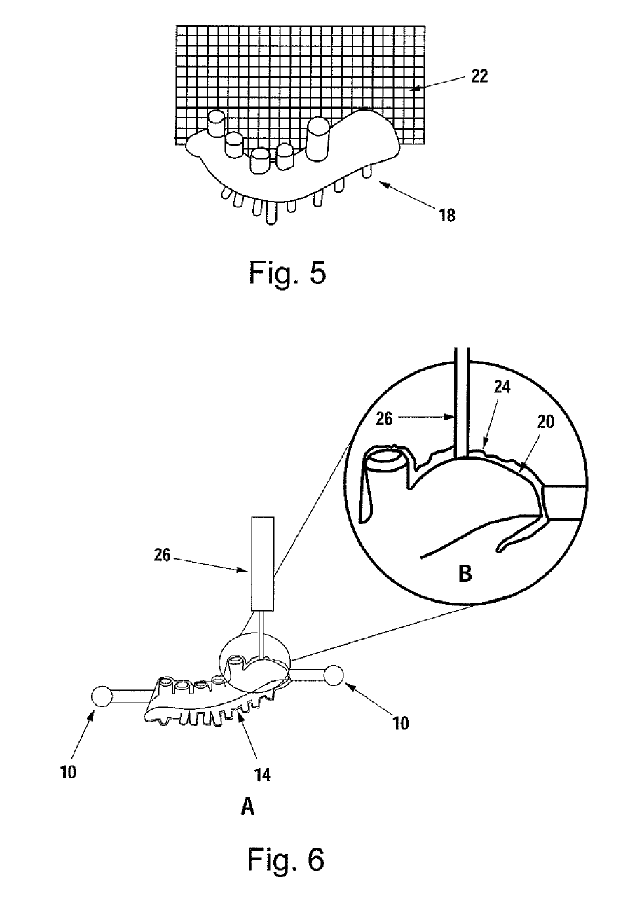

FIG. 5 illustrates the tool-paths for NC machining operations 22 desired to remove the excess material from the virtual EBM model 18 to create a precise finished metal or porcelain surface. In some preferred embodiments, computer software may generate the tool-paths for NC machining operations 22 from Boolean operations and may send the data to the five-axis NC mill 26 from the processing unit 502.

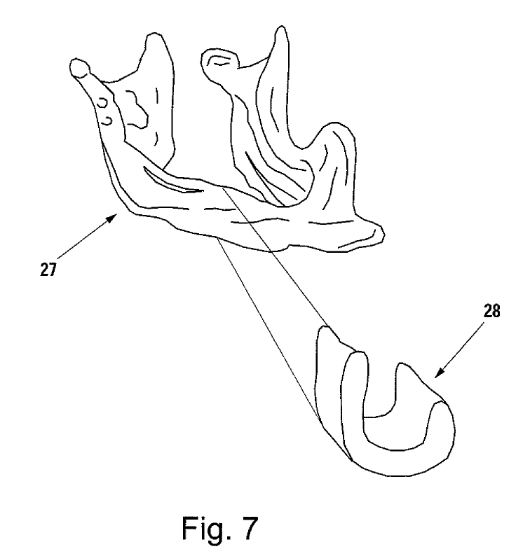

FIG. 6 illustrates the EBM part 14 with fixation struts 10 in a five-axis NC mill 26. Part B of FIG. 6 is an enlarged view of the indicated portion of part A showing the excess EBM material 24 of the part and the original three-dimensional CAD design of the part 20 with the five-axis NC mill 26 cutting the excess EBM material 24 to create a precise part consistent with the original CAD design.

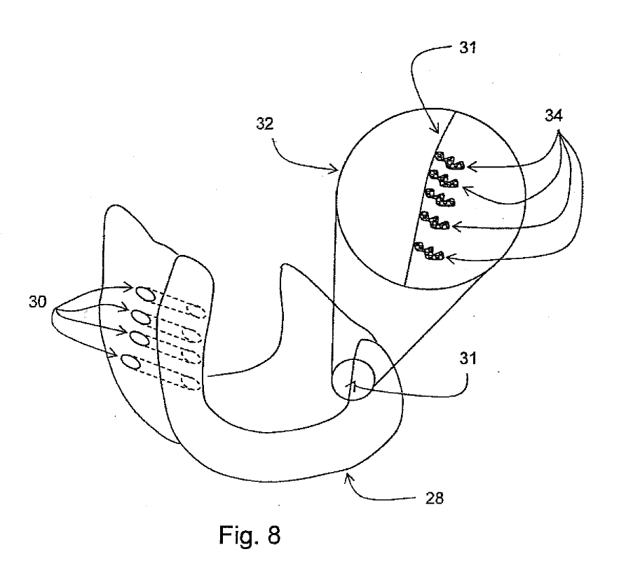

FIG. 7 illustrates a bone plate 27 made to replace a missing segment of a jaw bone. An enlarged cross sectional view of a bone plate 28 is also illustrated. Such a bone plate 27, 28 may be made according to the methods described above.

FIG. 8 is an enlarged cross sectional view of a bone plate 28 made with EBM. Unique holes and recesses 30 can be created in the CAD design and reproduced with EBM to provide spaces for bone in-growth into the bone plate. The size and form of these holes and recesses may be extremely difficult or impossible to produce with milling operations. An enlarged view 32 of an internal surface 31 of bone plate 28 illustrates the ability to create openings 34 in bone plate 27, or in any EBM manufactured part, that can be used to retain and deliver bio-active substances to the bone surface during healing. Again, such openings 34 may be extremely difficult or impossible to make using ordinary milling techniques.

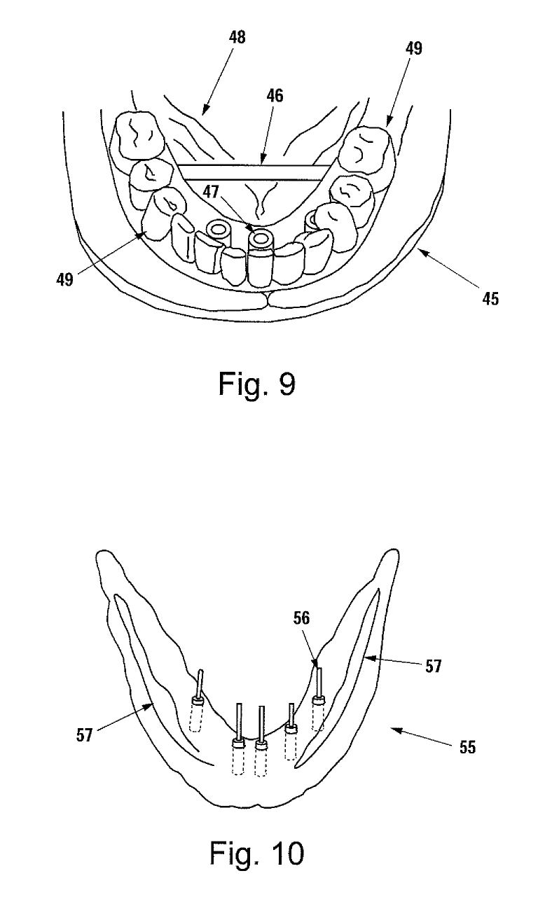

One embodiment shown in FIG. 9 is a top perspective view of a virtual design of a dental prosthesis 45. The user may design the prosthesis virtually in a CAD program using data from a CT scan and other data, including but not limited to an upper or lower dental cast. The virtual oral cavity and surrounding structures 48 provide a spacial orientation in computer space for a dental professional to build a dental device. Virtual artificial teeth 49, virtual design of a prosthesis 45, and bolt holes in the implant 47 may be measured and oriented in computer space before manufacturing the part using EBM. Once the dental or medical device is oriented and spaced correctly, the virtual data may be sent to an EBM machine 9 for manufacturing. A packing bar 46 may be used during shipping a dental device to ensure proper support for the prosthesis or implant.

FIG. 10 represents another embodiment displaying a front perspective view of a virtual treatment plan 55 for a patient receiving a dental device. A metal or porcelain EBM manufactured part may be milled to precise tolerances to fit accurately and to have a shape that is hygienic and aesthetic. In this embodiment, a three-dimensional rendering of the jaw bone may be used to determine the proper placement and size of virtual implants 56. A virtual treatment plan 55 may also allow a dental professional to plan for the actual restoration prior to implant placement. The virtual treatment plan 55 provides a three-dimensional model of the virtual implants 56, bone, restoration, and drill guide 57 that may be sent to a remote dentist or surgeon via the Internet to coordinate treatment or provide communication. Any object that can be visualized from the CT data, dental casts, or scanned directly can be joined in virtual space to create a composite computer model. FIG. 10 combines CT data with virtual implants 56 and the shape of the drill guide 57 into one composite three-dimensional image. A dentist or surgeon, for instance, may want to locate the mandibular nerve for a particular patient and position the virtual implants 56 away from the nerve. The various desired parts may be designed in virtual space and manufactured as described above.

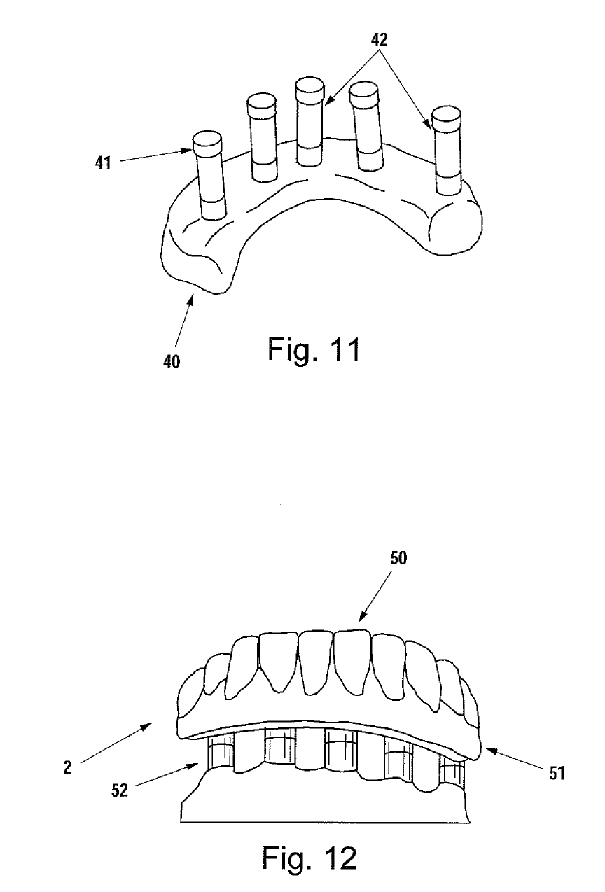

As shown in FIG. 11, a polished titanium part 40 after NC milling may include titanium struts 42 that may extend into artificial teeth to increase the strength and retention of the processed teeth. Additionally, copings 41 may be provided to protect the titanium struts 42. FIG. 12 displays artificial teeth 50 that may be positioned on the titanium struts 52. An opaque pink material 51 may be applied onto the artificial teeth 50 and titanium struts 52 to create a completed dental prosthesis 2. The opaque pink material 51 improves the aesthetics of the completed dental prosthesis 2 and it may help fasten the artificial teeth 50 onto the titanium struts 42. In some embodiments, the opaque pink material 51 may be applied under a vacuum to ensure a tight seal of the components of a completed dental prosthesis 2. Of course, other materials, components, and colors may be used if desired.

FIG. 13 illustrates a dental prosthesis 1 and an artificial bone plate 3 attached to a jaw bone 5. Artificial teeth 50 may be attached to the completed dental prosthesis 2 before implanting the device in the patient.

A dentist may receive artificial teeth 50, an opaque pink material 51, and a drill guide 57. The dentist may then assemble the components of a completed dental prosthesis 2 and use the drill guide 57 to install the completed dental prosthesis 2. Alternatively, a dentist could receive a completed prosthesis 2 that is ready to be installed. A person skilled in the art will recognize that a dentist may also assemble other medical or dental devices manufactured using EBM and NC milling. In an alternate embodiment, an automated mechanical robot could glue the artificial teeth 50 to the titanium struts 52.

Although various exemplary embodiments have been shown and described, the invention is not limited to the embodiments shown and described. Therefore, the scope of the invention is intended to be limited solely by the scope of the claims that follow, considering the doctrine of equivalents.

What is claimed is:

1. A method of making a medical or dental part comprising:
creating a first digital model of said part;
manufacturing an initial embodiment of said part based on said first digital model using a layered manufacturing process;
creating a second digital model of said initial embodiment;
determining a difference between said second digital model and said first digital model; and
machining said initial embodiment to create a final embodiment of said part by removing an amount of material substantially representative of said difference.

2. The method of claim 1 wherein said layered manufacturing process comprises EBM.

3. The method of claim 1 wherein said machining comprises using a NC machine.

4. The method of claim 1 wherein said first digital model of said part is created in the context of a digital model of at least a portion of a patient's anatomy.

5. The method of claim 1 wherein said second digital model is created using a machine selected from a contact digitizer, a laser imaging machine, and a light imaging machine.

6. The method of claim 1 wherein said first digital model comprises data representative of at least one hole or recess that is formed in said initial embodiment of said part during said manufacturing.

7. The method of claim 6 wherein said at least one hole or recess is adaptable for facilitating in-growth of bone or tissue after said part is installed in a patient.

8. The method of claim 6 wherein said at least one hole or recess is adaptable for containing a substance to promote tissue growth after said part is installed in a patient.

9. A computer readable medium comprising instructions for:
creating a first digital model of a medical or dental part;
manufacturing an initial embodiment of said part based on said first digital model using a layered manufacturing process;
creating a second digital model of said initial embodiment;
determining a difference between said second digital model and said first digital model; and
machining said initial embodiment to create a final embodiment of said part by removing an amount of material substantially representative of said difference.

10. The computer readable medium of claim 9 wherein said layered manufacturing process comprises EBM.

11. The computer readable medium of claim 9 wherein said machining comprises using a NC machine.

12. The computer readable medium of claim 9 wherein said first digital model of said part is created in the context of a digital model of at least a portion of a patient's anatomy.

13. The computer readable medium of claim 9 wherein said second digital model is created using a machine selected from a contact digitizer, a laser imaging machine, and a light imaging machine.

14. The computer readable medium of claim 9 wherein said first digital model comprises data representative of at least one hole or recess that is formed in said initial embodiment of said part during said manufacturing.

15. The computer readable medium of claim 14 wherein said first digital model comprises data representative of at least one hole or recess adaptable for facilitating in-growth of bone or tissue after said part is installed in a patient.

16. The computer readable medium of claim 14 wherein said first digital model comprises data representative of at least one hole or recess adaptable for containing a substance to promote tissue growth after said part is installed in a patient.
